(19) United States
(12) Patent Application Publication
(10) Pub. No.: US 2022/0288686 A1
(43) Pub. Date: Sep. 15, 2022

(54) Binder Jet Particulate And Molded Products

(71) Applicant: Tundra Composites, LLC, White Bear Lake, MN (US)

(72) Inventor: Kurt Heikkila, Marine on the St. Croix, MN (US)

(73) Assignee: Tundra Composites, LLC, White Bear Lake, MN (US)

(21) Appl. No.: 17/692,680

(22) Filed: Mar. 11, 2022

Related U.S. Application Data
(60) Provisional application No. 63/160,105, filed on Mar. 12, 2021.

(51) Int. Cl. B22F 10/14; B29C 64/165; B28B 1/00; B33Y 70/00

(52) U.S. Cl. CPC B22F 10/14; B29C 64/165; B28B 1/001; B33Y 70/00; B29K 2063/00

(57) ABSTRACT

Disclosed are interfacially modified particulate for use in binder jet molding processes for metals and other composite particulate materials.

### CROSS REFERENCE TO RELATED APPLICATIONS

This application claims the benefit of a U.S. Patent Provisional Application Ser. No. 63/160,105, filed Mar. 12, 2021. This application is hereby incorporated by reference in its entirety.

### FIELD

Embodiments disclosed herein relate to interfacially modified particulate material for use in a part or component making using binder jet processes. Improved solid body products are provided that are produced by sintering the interfacial modified powder.

### BACKGROUND

The use of inorganic or metal powders in making objects using techniques such as injection molding, press and sinter and in metal injection molding (MIM) processes is a mature technology. Recent developments include the utility of new materials and manufacturing techniques. For example, injection molding uses a variety of inorganic and metallic powders as a raw material from which a variety of product shapes and parts can be made. Precise shapes that perform uses in many commercial and consumer-based products have been made. Applications include automotive applications, aerospace applications, consumer durable goods, computer applications, medical applications, and others. Inorganic and/or metal powders are consolidated or densified into specific shapes through several different production processes.

A substantial need for the improvement of both the products and the processes of forming or compaction in this industry. The feedstock of the powder material is often difficult to mold due to the materials lack of flow characteristics, physical and mechanical properties, and lack of self-ordering and non-optimal packing of particle or fractions. In certain instances, the products made with MIM, press and sinter etc. processes do not have the commercially effective appearance or physical properties for many applications. Often, the green body and final article, have defects such as a failure to maintain quality in obtaining size uniformity, an absence of green strength, density, or other needed properties because of insufficient particle packing and subsequent inefficient particle bonding. Further, the energy required to initially conform or eject the particulate mass to a particular shape such that the shape is complete and well-formed is excessive. The machines that initially form or compact the objects do not uniformly or fully fill the whole space with powder resulting in a malformed part or unit.

The binder jet process is an additive manufacturing process in which a printhead can be used to deposit a typically aqueous liquid binding agent onto a thin layer of a particulate material. The binding agent forms the portion of the object within the layer. Finishing all layers can form the final green object. The particulate can comprise a metal, ceramic, or inorganic particulate. The result of a binder jet process is a series of thin layers of particulates having an amount of the typically aqueous liquid binding agent that can be used to form a green article. Once the article is formed, the green article can then be sintered to manufacturer components, parts, or tooling objects. The process forming repeated layers of particles with the binder material is formed using an object file in the form of a computer readable 3D program that forms the binder into the desired forms layer by layer until the object is complete. Once the object is complete, it can then be sintered into a final product.

All additive manufacturing processes use a particulate material that in one form or another, and depending on the process used, is formed into a final product. In typically additive manufacturing processes, the packing density of the initial green object is maximized to obtain the highest density material in the final product. The desirable properties of the product are typically obtained using the highly packed green product. We have found that the binder jet process, not unlike other additive processes, suffers from the drawback that it cannot obtain the highest density in the green object and in the sintered object. We have found that a small amount of the coating of an interfacial modifier on the particulate can achieve packing densities more than those packing densities of typical additive manufacturing processes, including binder jet processes. A substantial need exists to improve binder jet molding techniques to obtain improved in packing and density.

### BRIEF DESCRIPTION

We have found that by forming a metal particulate comprising a particle with a coating of an interfacial modifier on the particle can be readily formed into a useful product via binder jet additive manufacturing and sintering. We have found that we can reduce shrinkage in sintering while at least maintaining physical and mechanical properties. We can make larger parts, reduce shrinkage by substantially improving packing fraction reducing the interior excluded volume that is reduced by sintering. We can make parts with a linear dimension of greater than 16 cm while maintain ng uniformity is product inventory and maintain at least current physical and mechanical properties. Currently we are limited only by available print bed sizing.

The embodiment further relates to a particulate material with a coating of an interfacial modifier that through the selection of particle type, particle size, particle shape, and interfacial modifier can form a composite to provide substantially improved molded solid body products. The use of an interfacial modified particulate permits very high packing fractions of the particles as the particles tend to self-order themselves to achieve the highest packing density in a volume of the particles. The coating of interfacial modifier on the particulate results in reduced shrinkage of the mass of particulate in the part or shaped article during the processes. Reduced shrinkage provides reproducibility of the part or shaped article. Further, the resulting molded products can exceed contemporary products at least in tensile strength, impact strength and density.

We have found that the green body and final products of the processes can be improved through the increased packing density of the particulate in the green and final products. The packing density, or packing fraction, is a useful predictor of the properties of the resulting products. The improved packing density typically has improved strength, shielding properties, shape, definition, etc. of the final sintered product or shaped solid body article.

In one embodiment, a selected metal particulate having specified particle metallurgy can be combined with a specific amount of an interfacial modifier to form a coating of the modifier on a particle to form a green body by molding such as injection molding prior to sintering.

In one embodiment, a selected particulate having specified particle metallurgy can be combined with a specific amount of an interfacial modifier to form a coating of the modifier on a particle to form a green body by press and sintering techniques prior to sintering.

In another embodiment, an extrusion process can be used with the interfacially modified particulate to obtain improved processing properties. Using the interfacial modifier, the extrusion produced products and injection molding products, including the green product, filaments, and the final sintered product, can be obtained with minimum excluded volume and maximum particulate packing densities.

The term “green strength” or “green product” indicates the nature of the property or product when initially formed prior to being heated or sintered to form the final shaped article.

The term “green strength resistance to gravitational distortion” indicates the resistance of the product to dimensional distortion in the green shaped article after molding but before sintering.

The term “final shaped article” as used in this disclosure refers to the final product of the process, such that a final product is made by first forming a green product and then sintering or heating the green product until it forms particle-to-particle bonding, necking, resulting in the final product shape.

The term “particulate” refers to a collection of finely divided particles that can be ceramic, inorganic or metallic. The particulate has a range of sizes and morphologies. The maximum particle size is less than 500 microns. A formed body containing the interfacially modified particulate is sintered at elevated temperature to form a desired object.

The term “elevated temperature” refers to a temperature sufficient or thermal process to cause the temperature driven removal of organic materials such as organic and binder materials. Such temperatures can be used in “sintering” or “debinding.” Sintering is done at a temperature and time sufficient to cause the particulate to form a solid object. Such object formation can occur by any temperature driven particulate bonding including softening, melting, particle to particle edge fusion. An initial lower temperature debinding step can be used to remove volatiles before heating to a sinter temperature. Often, no “debinding” step is needed in this technology. The term “x-y plane” generally refers to a horizontally positioned orthogonal to the force of gravity. The z-direction generally refers to the direction parallel to the force of gravity and substantially orthogonal to the x-y plane.

The inorganic, ceramic or metallic particles typically have a particle size that ranges from about 1 to 500, 1.2 to 400, 2 to 300, 3 to 200, or 1 to 100 microns, 1 to 300, 1 to 200, or 1 to 300 microns, and often 5 to 250, 5 to 150, 5 to 100, 5 to 75, or 1 to 75 microns. A combination of a larger and a smaller particle wherein there is about 0.1 to 25 wt. % of the smaller particle and about 99.9 to about 75 wt. % of larger particles can be used where the ratio of the diameter of the larger particles to the ratio of the smaller is about 2:1, 3:1, 4:1, 5:1, 6:1 or 7:1. In some embodiments there may be three or more components of particle sizes such as 49:7:1 or 343:49:7:1. In other embodiments there may be a continuous gradient of wide particle size distributions to provide higher packing densities or packing fractions. These ratios will provide optimum self-ordering of particles leading to tunable particle fractions within the composite material. The self-ordering of the particles is improved with the addition of interfacial modifier as a coating on the surface of the particle.

The packing density or particle fraction of particles in the composite material varies to specifications required for the utility of the final shaped product as molded and sintered. Values for packing density, volume percent, may be greater than 70, 75, 80, 85, 90, 95, or 99%. Packing can also be seen in the amount of excluded volume. Excluded volume is the volume not occupied by the particulate. The process can also provide minimal shrinkage less than 10, 5, 4, or 3 vol. %, depending on particulate and IM selection. and often permits part manufacture to avoid a debinding step

We believe an interfacial modifier is a surface chemical treatment. In one embodiment, the interfacial modifier is an organic material that provides an exterior coating on the particulate promoting the close association of particulate to other particulate without intra-particulate bonding or attachment. Minimal amounts of the interfacial modifier can be used including about 0.005 to 8 wt.-%, 0.005 to 4 wt.-%, 0.010 to 3 wt. %, 0.1 to 5 wt. %, 0.02 to 3 wt. % or about, 0.02 to 2 wt. %. The interfacial modifier coats but does not form any substantial covalent bonding among or to other particulate.

### DETAILED DISCUSSION

Interfacial modifiers provide the close association of the particulate within a particle distribution of one or many sizes. Interfacial modifiers used in the application fall into broad categories including, for example titanate compounds, zirconate compounds, hafnium compounds, samarium compounds, strontium compounds, neodymium compounds, yttrium compounds, phosphonate compounds, aluminate compounds and mixtures thereof. Useful, aluminate, phosphonate, titanate, and zirconate compounds useful contain from about 1 to about 3 ligands comprising hydrocarbyl phosphate esters and/or hydrocarbyl sulfonate esters and about 1 to 3 hydrocarbyl ligands which may further contain unsaturation and heteroatoms such as oxygen, nitrogen and sulfur. Commonly the titanate and zirconate compounds contain from about 2 to about 3 ligands comprising hydrocarbyl phosphate esters and/or hydrocarbyl sulfonate esters, commonly 3 of such ligands and about 1 to 2 hydrocarbyl ligands, commonly 1 hydrocarbyl ligand. The specific type of organo-titanate, organo-aluminate, organo-hafnium, organo-strontium, organo-neodymium, organo-yttrium, or organo-zirconate compounds or mixtures thereof may be referred to as organo-metallic compounds are distinguished by the presence of at least one hydrolysable group and at least one organic moiety. Mixtures of the organo-metallic materials may be used. The interfacial modifier or mixture of the interfacial modifiers may be applied inter- or intra-particle, which means at least one particle may have more than one interfacial modifier coating the surface (intra), or more than one interfacial modifier coating may be applied to different particles or particle size distributions (inter). These types of compounds may be defined by the following general formula:

M(R₁)ₙ(R₂)ₘ

wherein M is a central atom selected from, for example, Ti, Al, Hf, Sa, Sr, Nd, Yt, and Zr; R₁ is a hydrolysable group; R₂ is a group consisting of an organic moiety; wherein the sum of m+n must equal the coordination number of the central atom and where n is an integer ≥1 and m is an integer ≥1.

Particularly R₁ is an alkoxy group having less than 12 carbon atoms. Useful are those alkoxy groups, which have less than 6, and most Useful are alkoxy groups having 1-3 C atoms. R₂ is an organic group including between 6-30, commonly 10-24 carbon atoms optionally including one or more hetero atoms selected from the group consisting of N, O, S and P. R₂ is a group consisting of an organic moiety, which is not easily hydrolyzed and often lipophilic and can be a chain of an alkyl, ether, ester, phospho-alkyl, phospho-alkyl, phospho-lipid, or phospho-amine. The phosphorus may be present as phosphate, pyrophosphato, or phosphito groups. Furthermore, R₂ may be linear, branched, cyclic, or aromatic.

Useful titanate and zirconate compounds include isopropyl tri(dioctyl)pyrophosphato titanate (available from Kenrich Chemicals under the designation KR38S), neopentyl(diallyl)oxy, tri(dodecyl)benzene-sulfonyl titanate (available from Kenrich Chemicals under the trademark and designation LICA 09), neopentyl(diallyl)oxy, trioctylphosphato titanate (available from Kenrich Chemicals under the trademark and designation LICA 12), neopentyl(diallyl)oxy, tri(dodecyl)benzene-sulfonyl zirconate (available from Kenrich Chemicals under the designation NZ 09), neopentyl(diallyl)oxy, tri(dioctyl)phosphato zirconate (available from Kenrich Chemicals under the designation NZ 12), and neopentyl(diallyl)oxy, tri(dioctyl)pyro-phosphato zirconate (available from Kenrich Chemicals under the designation NZ 38). One embodiment is titanate is tri(dodecyl)benzene-sulfonyl titanate (available from Kenrich Chemicals under the designation LICA 09). The interfacial modifiers modify the particulate in the materials with the formation of a layer on the surface of the particle reducing the intermolecular forces, improving the tendency of particle to mix with other particles, and resulting in increased material density. Interfacial modifier coatings on particulate, in contrast with uncoated particulate, maintain or improve tensile modulus, storage modulus, elastic-plastic deformation and tensile elongation can be present in the composite material. Interfacial modifiers coatings on particulate also improve the rheology of the composite material causing less wear on machinery and other technology useful in melt processing. Further, the interfacial modifier coatings on particulate provide an inert surface on the particulate substrate.

The choice of interfacial modifiers is dictated by particulate, and application. The particle is completely and uniformly coated with the interfacial modifier even if having substantial surface morphology. By substantial surface morphology, visual inspection would show a rough surface to a particle substrate where the surface area of the rough substrate, considering the topography of the surface, is substantially greater than the surface area of a smooth substrate.

Particles contact one another and the combination of irregular shape, interacting sharp edges, soft surfaces (resulting in gouging, points are usually work hardened) and the friction between the surfaces prevent further or optimal packing. Therefore, maximizing properties, such as increasing the flow properties, reducing viscosity, the particulate mass of a material, is a function of softness of surface, hardness of edges, point size of point (sharpness), surface friction force and pressure on the material, circularity, and the usual, shape size distribution. In general, these effects are defined as particle surface energy interactions. Such interactions can be inhibitory to forming materials with requisite properties such as high density or low porosity. Further because of this inter-particle friction, the forming pressure will decrease exponentially with distance from the applied force.

Interfacially modifying chemistries can modify the surface of the particulate populations by a variety of means. For example, there may be coordination bonding, Van der Waals forces, covalent bonding, or a combination of all three at the surface of the particulate with the interfacial modifier. The interfacial modifier will be completely and uniformly associated with the surface of the particulate. In some instances, the surface of the particulate will be completely coated by the interfacial modifier. After treatment with the interfacial modifier, the surface of the particle behaves as a particle of the non-reacted end of the interfacial modifier. Thus, the interfacial modifier associates with the surface of the particle and in some cases the chemistry of the interfacial modifier may form bonds with the surface of the particle thereby modifying the surface energy of the bulk particulate relative to the surface characteristics of the interfacial modifier.

With interfacial modifiers the topography of particle surfaces, surface morphology, such as for example, roughness, irregular shape etc., is modified to reduce these inter-particle surface effects. The particulate distribution with individual particles having an interfacially modified surface, although perhaps comprising different particle sizes, has a more apparent homogeneous surface in comparison to non-interfacially modified particulate. The interfacial modifier reduces, such as for example, surface energies on the particle surface permitting a denser packing of particle distributions. In one embodiment the reduction of particle surface energy due to interfacial modification of particle surfaces provides self-ordering of different particle sizes to proceed. In contrast, articles without interfacial modification will resist self-ordering. These organic materials of the interfacial modifiers not only are non-reactive to each other but also reduce the friction between particles thereby preventing gouging and allowing for greater freedom of movement among and between particles in comparison to particles that do not have a coating of interfacial modifier on their surface. These phenomena allow the applied shaping force to reach deeper into the form resulting in a more uniform pressure gradient during processing.

The physical properties of the green part are substantially improved by the packing and self-ordered particulate. Such improved physical properties in the green part results in a product that can be shaped, processed, and handled with minimal concern for product damage before sintering Density was measured with the following procedures:

Procedures to measure the loading ratio of treated, or coated, particles calculated based upon pycnometer density and powder press density, as shown in Equation 1.

$$Maximum Loading = \frac{Powder Puck Density}{Pycnometer Density} \qquad ( Eq . 1 )$$

Similarly, the green part and brown body is resistant to dimensional change after molding but before sintering. In parts without substantial packing and self-ordering, after part formation but before sintering, portions of complex parts, having reduced dimensions, can be distorted by gravity forces. Such parts require a molded support when molded but before sintering. After sintering the support must be removed mechanically, a step that can cause product damage to sensitive parts. The green parts claimed can be made with no such supports in both simple and complex parts. As a result, the claimed technology results in reduced waste and reduced post sintering processing Such dimensional change can be directly observed in a green part.

Metals

The powder particles can consist of a single crystal or many crystal grains of various sizes. The microstructure including a crystal grain size shape and orientation can also vary from metal to metal. The particle metallurgy depends on method of the particle fabrication. Metals that can be used in powder metal technology include copper metal, iron metal, nickel metal, tungsten metal, molybdenum, and metal alloys thereof and bi-metallic particles thereof. Often, such particles have an oxide layer that can interfere with shape formation. The metal particle composition used in particle metallurgy typically includes a large number of particulate size materials. The particles that are acceptable are molding grade particulate including a workable particle size, particle size distribution, particle morphology, including reference index and aspect ratio. Further, the flow rate of the particle mass, the green strength of the initial shaped object, the object toughness, compressibility of the initial shaped object, the removability or ejectability of the shaped object from the mold, and the dimensional stability of the initial shape during processing and later sintering is also important.

Metal particulate that can be used in the sold body molded composite materials include tungsten, uranium, osmium, iridium, platinum, rhenium, gold, neptunium, plutonium and tantalum. Other metals that can be used are iron, copper, nickel, cobalt, tin, bismuth and zinc. These metals may be used alone or in conjunction with other metals, inorganic minerals, ceramics, or glass bubbles and spheres. The end use of the material to make the shaped article would be the determining factor. While an advantage is that non-toxic or non-radioactive materials can be used as a substitute for lead and depleted uranium where needed, lead and uranium can be used when the materials have no adverse impact on the intended use. Another advantage is the ability to create bimetallic or higher materials that use two or more metal materials that cannot naturally form an alloy. In another embodiment, using the press and sinter process. A variety of properties can be tailored through a careful selection of metal or a combination of metals and the toxicity or radioactivity of the materials can be designed into the materials as desired.

These materials are not used as large metal particles, but are typically used as small metal particles, commonly called metal particulates. Such particulates have a relatively low aspect ratio and are typically less than about 1:3 aspect ratio. An aspect ratio is typically defined as the ratio of the greatest diameter of the particulate divided by the smallest length of the particulate. Generally, spherical particulates (reasonably close to 1:1) are commonly used; however, sufficient packing densities can be obtained from relatively uniformly shaped particles in a dense structure. In some embodiments, the particles may be ball milled to provide mostly round particles. In some instances, the ball-milled particle can have some flat spots. In Press and Sinter processes, heterogeneous shapes and sizes are more useful than spherical particulate. Using the interfacial modifier coating enables the part or shaped article to be ejected from the die with less force than a part or article that is not coated with the interfacial modifier.

Ceramics

Another important inorganic material that can be used as a particulate includes ceramic materials. Ceramics are typically classified into three distinct material categories, including aluminum oxide and zirconium oxide ceramic, metal carbide, metal boride, metal nitride, metal silicide compounds, and ceramic material formed from clay or clay-type sources. Examples of useful technical ceramic materials are selected from barium titanate, boron nitride, lead zirconate or lead tantalite, silicate aluminum oxynitride, silica carbide, silica nitride, magnesium silicate, titanium carbide, zinc oxide, and/or zinc dioxide (zirconia) particularly useful ceramics of use comprise the crystalline ceramics. Other embodiments include the silica aluminum ceramic materials that can be made into useful particulate. Such ceramics are substantially water insoluble and have a particle size that ranges from about 10 to 500 microns, have a density that ranges from about 1.5 to 3 gram/cc and are commercially available. In an embodiment, soda lime glass may be useful. One useful ceramic product is the 3M ceramic microsphere material such as the g-200, g-400, g-600, g-800 and g-850 products.

Magnetic composites can be made of any magnetic particle material that when formed into a composite can be magnetized to obtain a permanent magnetic field. These particles are typically inorganic and can be ceramic. Magnetite is a mineral, one of the two common naturally occurring oxides of Iron (chemical formula Fe₃O₄) and a member of the spinel group. Magnetite is the most magnetic of all the naturally occurring minerals. Alnico magnet alloy is largely comprised of aluminum, iron, cobalt and nickel. Alnico is a moderately expensive magnet material because of the cobalt and nickel content. Alnico magnet alloy has a high maximum operating temperature and a very good corrosion resistance. Some grades of Alnico alloy can operate upwards of 550° C. Samarium cobalt (SmCo) and Neodymium Iron Boron (NdFeB) are called rare earth because neodymium and samarium are found in the rare earth elements on the periodic table. Both samarium, cobalt, and neodymium magnet alloys are powdered metals which are compacted in the presence of a strong magnetic field and are then sintered. Ceramic magnet material (Ferrite) is strontium ferrite. Ceramic magnet material (Ferrite) is one of the most cost-effective magnetic materials manufactured in industry. The low cost is due to the cheap, abundant, and non-strategic raw materials used in manufacturing this alloy. The permanent ceramic magnets made with this material lend themselves to large production runs. Ceramic magnet material (Ferrite) has a fair to good resistance to corrosion and it can operate in moderate heat.

Useful magnetic particles are ferrite materials. Ferrite is a chemical compound consisting of a ceramic inorganic oxide material. Ferric oxide commonly represented as Fe₂O₃ is a principal component. Useful ferrite materials of the disclosure have at least some magnetic character and can be used as permanent magnet ferrite cores for transformers and as memory components in tape and disc and in other applications. Ferrite materials are ferromagnetic ceramic compounds generally derived from iron oxides. Iron oxide compounds are materials containing iron and oxygen atoms. Most iron oxides do not exactly conform to a specific molecular formula and can be represented as Fe₂O₃ or Fe₃O₄ as well as compounds as FeₓO_{y} wherein X is about 1 to 3 and Y is about 1 to 4. The variation in these numbers result from the fundamental nature of the ferric oxide material which invoke often does not have precisely defined ratios of iron to oxygen atoms. These materials are spinel ferrites and are often in the form of a cubic crystalline structure. The crystalline usually synthetic ceramic material typically is manufactured by manufacturing a ferric oxide material and at least one other metallic oxide material generally made from a metal oxide wherein the model is a divalent metal. Such metals include for example magnesium, calcium, barium, chrome manganese, nickel, copper, zinc, molybdenum and others. The useful metals are magnesium, calcium and barium.

Useful ferrites are typically prepared using ceramic techniques. Often the oxides are carbonates of the iron or divalent oxides are milled until a fine particulate is obtained. The fine particulate is dried and pre-fired in order to obtain the homogenous end product. The ferrite is then often heated to form the final spinel crystalline structure. The preparation of ferrites is detailed in U.S. Pat. Nos. 2,723,238 and 2,723,239. Ferrites are often used as magnetic cores in conductors and transformers. Microwave devices such as glycerin tubes can use magnetic materials. Ferrites can be used as information storage in the form of tape and disc and can be used in electromagnetic transistors and in simple magnet objects. One useful magnetic material is zinc ferrite, another useful ferrite is barium ferrite other ferrites include soft ferrites such as manganese-zinc ferrite and nickel zinc ferrite. Other useful ferrites are hard ferrites including strontium ferrite, cobalt ferrite, etc.

In some greater detail, ferrites are typically produced by heating a mixture of finely divided metal oxide, carbonate or hydroxide with ferrite powder precursors when pressed into a mold. During the heating process the material is calcined. In calcination volatile materials are often driven off leaving the inorganic oxides in the appropriate crystal structure. Divalent metal oxide material is produced from carbonate sources. During calcination a mixture of oxide materials is produced from a heating or sintering of the blend, carbon dioxide is driven off leaving the divalent metal oxide.

We have further found that a blend of the magnetic particle and one, two, three or more different particles in particulate form can obtain important composite properties from all particulate materials in a composite structure. For example, a tungsten composite or other high density metal particulate can be blended with a second metal particulate that provides to the relatively stable, non-toxic tungsten material, additional properties including a low degree of radiation in the form of alpha, beta or gamma particles, a low degree of desired cytotoxicity, a change in appearance or other beneficial properties. One advantage of a bimetallic composite is obtained by careful selection of proportions resulting in a tailored magnetic strength for a particular end use. Such composites each can have unique or special properties. These composite processes and materials have the unique capacity and property that the composite acts as an alloy a blended composite of two or three different metals inorganic minerals that could not, due to melting point and other processing difficulties, be made into an alloy form without the disclosed embodiments.

Minerals

Examples of minerals that are useful in the embodiment include compounds such as Carbide, Nitride, Silicide and Phosphide; Sulphide, Selenide, Telluride, Arsenide and Bismuthide; Oxysulphide; Sulphosalt, such as Sulpharsenite, Sulphobismuthite, Sulphostannate, Sulphogermanate, Sulpharsenate, Sulphantimonate, Sulphovanadate and Sulphohalide; Oxide and Hydroxide; Halides, such as Fluoride, Chloride, Bromide and Iodide; Fluoroborate and Fluorosilicate; Borate; Carbonate; Nitrate; Silicate; Silicate of Aluminum; Silicate Containing Aluminum or other Metals; Silicates containing other Anions; Niobate and Tantalate; Phosphate; Arsenate such as arsenate with phosphate (without other anions); Vanadate (vanadate with arsenate or phosphate); Phosphates, Arsenates or Vanadate; Arsenite; Antimonate and Antimonite; Sulphate; Sulphate with Halide; Sulphite, Chromate, Molybdate and Tungstate; Selenite, Selenate, Tellurite, and Tellurate; Iodate; Thiocyanate; Oxalate, Citrate, Mellitate and Acetates include the arsenide, antimonide and bismuthide of e.g., metals such as Li, Na, Ca, Ba, Mg, Mn, Al, Ni, Zn, Ti, Fe, Cu, Ag and Au.

Garnet, is an important mineral and is a nesosilicate that complies with general formula X₃Y₂(SiO₄)₃. The X is divalent cation, typically Ca²⁺, Mg²⁺, Fe²⁺ etc. and the Y is trivalent cation, typically Al³⁺, Fe³⁺, Cr³⁺, etc. in an octahedral/tetrahedral framework with [SiO₄]⁴⁻ occupying the tetrahedral structure. Garnets are most often found in the dodecahedral form, less often in trapezo-hedral form.

One particularly useful inorganic material used are metal oxide materials including aluminum oxide or zirconium oxide. Aluminum oxide can be in an amorphous or crystalline form. Aluminum oxide is typically formed from sodium hydroxide, and aluminum ore. Aluminum oxide has a density that is about 3.8 to 4 g-cc and can be obtained in a variety of particle sizes that fall generally in the range of about 10 to 1,000 microns. Zirconium oxide is also a useful ceramic or inorganic material. Zirconium dioxide is crystalline and contains other oxide phases such as magnesium oxide, calcium oxide or cerium oxide. Zirconium oxide has a density of about 5.8 to 6 gm-cm⁻³ and is available in a variety of particle sizes. Another useful inorganic material concludes zirconium silicate. Zirconium silicate (ZrSiO₄) is an inorganic material of low toxicity that can be used as refractory materials. Zirconium dioxide has a density that ranges from about 4 to 5 gm/cc and is also available in a variety of particulate forms and sizes.

One important inorganic material that can be used as a particulate in another embodiment includes silica, silicon dioxide (SiO₂). Silica is commonly found as sand or as quartz crystalline materials. Also, silica is the major component of the cell walls of diatoms commonly obtained as diatomaceous earth. Silica, in the form of fused silica or glass, has fused silica or silica line-glass as fumed silica, as diatomaceous earth or other forms of silica has a material density of about 2.7 gm-cm⁻³ but a particulate density that ranges from about 1.5 to 2 gm-cm⁻³.

Glass Spheres

Glass spheres (including both hollow and solid) are another useful non-metal or inorganic particulate. These spheres are strong enough to avoid being crushed or broken during further processing, such as by high pressure spraying, kneading, extrusion or injection molding. In many cases these spheres have particle sizes close to the sizes of other particulate if mixed together as one material. Thus, they distribute evenly, homogeneously, within the composite upon introduction and mixing. The method of expanding solid glass particles into hollow glass spheres by heating is well known. See, e.g., U.S. Pat. No. 3,365,315 herein incorporated by reference in its entirety.

Useful hollow glass spheres having average densities of about 0.1 grams-cm⁻³ to approximately 0.7 grams-cm⁻³ or about 0.125 grams-cm⁻³ to approximately 0.6 grams-cm⁻³ are prepared by heating solid glass particles.

For a product of hollow glass spheres having a particular desired average density, there is an optimum sphere range of sizes of particles making up that product which produces the maximum average strength. A combination of a larger and a smaller glass sphere wherein there is about 0.1 to 25 wt. % of the smaller sphere and about 99.9 to about 75 wt. % of larger particles can be used were the ratio of the diameter of the larger particles to the ratio of the smaller is about 2:1, 3:1, 4:1, 5:1, 6:1 or 7:1.

Glass spheres used within the embodiments can include both solid and hollow glass spheres. All the particles heated in the furnace do not expand, and most hollow glass-sphere products are sold without separating the hollow from the solid spheres.

Useful glass spheres are hollow spheres with relatively thin walls. Such spheres typically comprise a silica-lime, borosilicate glass and in bulk form a white powdery particulate. The density of the hollow spherical materials tends to range from about 0.1 to 0.8 g/cc that is substantially water insoluble and has an average particle diameter that ranges from about 10 to 250 microns.

The composite materials having the desired physical properties can be manufactured as follows. In a useful mode, the surface coating of the particulate with the interfacial modifier is initially prepared. The interfacial modifier is coated on the prepared particle material. The coating of the interfacial modifier on the particle is less than 1 micron thick, in some cases atomic (0.5-10 Angstroms) or molecular dimensions (1-500 Angstroms) thick.

One aspect of a method for making an article using binder jet techniques uses a binder material. The binder material is typically aqueous in nature and can be manufactured from a variety of known water-soluble materials that can act to form a green body by binding selective particulate in each layer in the bed in a green shape necessary for sintering. The binder material can consist of a one-part or a two-part system wherein the one-part system comprises a solution of water-soluble material. A two-part system can comprise each a solution of reactive or non-reactive polymer materials that can interact when mixed and when contacted with the bed of particulate to form the green body. Polymer materials include a variety of thermoplastic and natural polymers. Polymers such as polyolefin, PVC, acrylics, urethanes can be used. Natural polymers including proteins and carbohydrates such as cellulosics and starches can be used. These are suitable if they can be volatilized in sintering processes. The binder is sprayed through a convectional orifice that is less than about 5 microns in diameter, under the control of a digital model of the desired object onto a thin layer of the particulate. Once the binder material is applied to the particulate and coats the particles, it can bond or be cured to bond the particle to particle in the individual layers of the particle mass in the bed. A binder is selected such that the binder can be easily applied, readily coats the particulate, binds the particulate into a green body and in sintering, is quickly volatilized and removed from the particle mass, leaving the desired object with little or no residue from the binder.

The embodiment of the method disclosed herein begins with the formation of a thin layer of a particulate that is used to form the article. Typically, in the binder jet technology, the layers of a particulate are formed on a stage that can be raised or lowered as desired in increments less than 1 mm. The process typically is initiated by depositing a very thin layer of particulate onto the stage. Any individual layer in the particle bed can have a thickness that ranges from about 1 micron up to 500 microns, 2 microns to 400 microns, 5 microns to 300 microns, 6 microns to 200 microns or 30 to 100 microns as needed by the computer model. The thickness of the layer can vary depending on the position of the layer in the vertical distribution of layers and can be variable depending on the nature of the digital control and the digital model of the desired object. Accordingly, a first layer can be a relatively thick layer followed by a thinner layer acting as a buffer that may or may not contain a binder material simply to isolate the desired object from the movable stage. Any layer can contain a sacrificial portion that can be used as a temporary handle, support, etc.

Following the deposition of a first layer of metal particulate followed by a second layer of metal particulate followed by a third layer of metal particulate, continuing as needed, the binder material can be selectively applied to any layer independently of the other layers to form the desired object.

The apparatus used to form the green object that can be later sintered typically includes a binder jet printer that can store and apply binder solution(s) under the control of the digital computer. The binder solution is applied through a printer head that is coupled to the reservoir of binder. The two- or multi-part binder is used, there are typically two or more reservoirs for the binder solution materials. Typically, in a three-dimensional object, each layer is unique in the distribution of the binder solution to fully embody the result object. The diameter of the binder droplet can be 50 to 200×10⁻¹² (50 to 200 Pico liter). Currently, this is equivalent to 1200 dpi printing sizes.

The binder jet printer is controlled using a digital computer that incorporates a digital model of the desired object wherein the electronic model is divided into layers, typically 20 to 100 microns, corresponding to the layers that will be formed in the bed. After a repeated formation (see dimensions above) of a thin layer of particulate, the application of the binder material, where needed, into each individual layer, the iterative process of forming the desired object layer by layer and binder application followed by binder application is used until the full object is represented in the mass of layered particulate in a complete form. Typically, once the shape of the desired object is formed in the layered particle bed, the particle bed is then cured such that the green object obtains a mechanical stability. The uncured, unbonded, non-bonded particulate is removed from the green body and the now mechanically stable intact green body is sent to a sintering step. Alternatively, certain reactive binder solutions once applied from a two-part reservoir can react in each layer of the bed, thus bonding the green body chemically without thermal intervention. However, many reactive binder materials can effectively be further cured using thermal methods.

### EXPERIMENTAL

### Example 1

In a standard binder jet chamber, a bed of less than 55-micron 316L stainless steel particle (coated with 0.5 pph of an organometallic IM) was formed.

TABLE 1
Test results Ex. 1
Evaluation of IM performance in maximum
density in unsintered coated 316L stainless steel.

| | Pycnometer | | Density |
|---|---|---|---|
| IM Coating | Apparent | Tapped | with 25 ton |
| pph | density | density | pressing |
| Uncoated | | | |
| 0.5 pph | 7.84 | 5.33 | 5.34 |
| coated | | | |

### Example 2

In a standard binder jet experimental chamber, a bimodal particulate bed of 80 wt. % 316L stainless steel (microns particle size less than 50 microns, coated with 0.2 pph of an organometallic IM) and about 20 wt. % of 316L stainless steel 5-10 micron of coated with 0.02 pph of an organometallic IM was formed. The bed was used as is or pressed at 25 tones and density was measured in unsintered materials.

TABLE 2
Test results Ex. 2
Evaluation of IM performance in maximum
density in fusing 316L stainless steel.

| | | | Sintered density |
|---|---|---|---|
| IM Coating | pycnometer | Tapped | with 25 ton |
| pph | density | density | pressing |
| 0.5 | 7.75 | 5.46 | 6.19 |

The bed was exposed conventionally to laser radiation and the bed was fused the sintered densities are expected to be the same but in a steel sample with some shrinkage.

### Example 3

In a standard binder jet experimental chamber, a bimodal particulate bed of 80 wt. % 316L stainless steel (5-45 microns particle size (coated with 0.2 pph of an organometallic IM) and about 20 wt. % of 316L stainless steel 5-10 micron of coated with 0.2 pph of an organometallic IM was formed. The bed was used as is or pressed at 25 tones and density was measured in unsintered materials.

TABLE 2
Test results Ex. 3
Evaluation of IM performance in maximum
density in fusing 316L stainless steel.

| | | | Sintered density |
|---|---|---|---|
| IM Coating | Apparent | Tapped | with 25 ton |
| pph | density | density | pressing |
| 0.0 | 4 | 5.491 | 7.52 |
| 0.1 | 3.77 | 5.622 | 7.54 |
| 0.2 | 3.42 | 5.589 | 7.63 |
| 0.4 | 4.05 | 5.511 | 7.65 |
| 0.6 | 3.98 | 5.340 | 7.66 |
| 0.8 | 3.76 | 5.122 | 7.65 |

The bed was exposed conventionally to laser radiation and the bed was fused the sintered densities are expected to be the same but in a steel sample with some shrinkage.

The graphical and tabulated results of an experiment performed to demonstrate the effect of coating level on improving packing performance in a powder bed environment compared to uncoated particulate. The coating level was likely to be lower than needed in a polymer composite matrix to improve rheology and other physical properties. All data points to an optimum coating level of 0.1 to 0.5 pph±for this stainless particulate. The same evaluation is ongoing for finer powders (−45 microns and −20 microns), but the results are likely to be the same when accounting for surface area. The claims may suitably comprise, consist of, or consist essentially of, or be substantially free or free of any of the disclosed or recited elements. The claimed technology is illustratively disclosed herein can also be suitably practiced in the absence of any element which is not specifically disclosed herein. The various embodiments described above are provided by way of illustration and should not be construed to limit the claims attached hereto. Various modifications and changes may be made without following the example embodiments and applications illustrated and described herein, and without departing from the true spirit and scope of the following claims.

While the above specification shows an enabling disclosure of the composite technology, other embodiments may be made with the claimed materials.

We claim:

1. A particle bed comprising a particulate having a particle size of about 0.5 to about 300 microns, the bed adapted and conformed to binder jet process parameters, the bed having a minimum and maximum dimension of at least 5 centimeters, the bed comprising a series of formed layers having a thickness of less than about 1 millimeter, each layer comprising a plurality of particles having a coating of about 0.5 to about 5 weight percent of an interfacial modifier.

2. The bed of claim 1 wherein the particulate also comprises a binder composition.

3. The bed of claim 1 wherein the binder comprises an aqueous solution of a thermoplastic synthetic polymer or a natural polymer.

4. The bed of claim 3 wherein the binder solution is a two-part reactive epoxy or urethane polymeric aqueous soluble binder material.

5. The bed of claim 1 wherein the particulate is a metal powder.

6. The bed of claim 5 wherein the metal powder comprises nickel, titanium, cobalt, aluminum, tungsten, iron.

7. The bed of claim 5 wherein the metal powder comprises alloys thereof.

8. The bed of claim 5 wherein the metal powder comprises mixed particulates thereof.

9. The bed of claim 1 wherein the particulate comprises a ceramic particulate.

10. The bed of claim 9 wherein the ceramic particulate comprises a solid glass sphere or a hollow glass sphere.

11. An article comprising a green article derived from the bed of claim 1.

12. An article comprising the sintered bed comprising green article of claim 1.

13. A layer comprising a bed of particulates having a particle size of about 0.5 and 100 microns adapted and conformed to binder jet processing, the bed having a thickness of less than about 1 millimeter and a minimum and maximum length and width of at least 5 centimeters comprising a plurality of particulates having a coating of about 0.5 to about 5 weight percent of an interfacial modifier.

14. The layer of claim 13 wherein the particulate also comprises a binder composition wherein the binder comprises an aqueous solution of a thermoplastic synthetic polymer or a natural polymer.

15. The layer of claim 13 wherein the binder comprises an aqueous solution of a thermoplastic synthetic polymer or a natural polymer.

16. The layer of claim 15 wherein the binder solution is a two-part reactive polymeric aqueous soluble binder material.

17. The layer of claim 13 wherein the particulate is a metal powder.

18. The layer of claim 17 wherein the metal powder comprises nickel, titanium, cobalt, aluminum, tungsten, iron.

19. The layer of claim 17 wherein the metal powder comprises alloys thereof.

20. The layer of claim 17 wherein the metal powder comprises mixed particulates thereof.

21. The layer of claim 13 wherein the particulate comprises a ceramic particulate.

22. The layer of claim 21 wherein the ceramic particulate comprises a solid glass sphere or a hollow glass sphere.

23. The layer of claim 13 wherein the binder solution is a two-part reactive polymeric aqueous soluble binder.
